(19) United States
(12) Patent Application Publication
(10) Pub. No.: US 2004/0007439 A1
(43) Pub. Date: Jan. 15, 2004

(54) System for transferring conveyed items piece by piece

(75) Inventor: Christoph Wolkerstorfer, Niederwaldkirchen (AT)

Correspondence Address: COLLARD & ROE, P.C., 1077 Northern Boulevard, Roslyn, NY, 11576, US

(73) Assignee: TGW TRANSPORTGERATE GMBH & CO. KG.

(21) Appl. No.: 10/607,625

(22) Filed: Jun. 27, 2003

(30) Foreign Application Priority Data
Jul. 11, 2002 (AT) A 1045/2002

(51) Int. Cl. B65G 15/58

(52) U.S. Cl. 198/468.6

(57) ABSTRACT

The invention relates to a transfer system (1) for items conveyed (3) piece by piece between a first conveyor unit (4; 11) and at least one other conveyor unit (5, 6) extending transversely or at an angle thereto. The conveyed items (3) are fed on a substantially horizontal conveyor plane (21 ) of a corresponding conveyor system (2). The transfer system (1) has a brake mechanism (35) which can be raised above and lowered below the conveyor plane (21) so that it can be selectively placed in and out of friction contact with the bottom face (36) of the conveyed item (3). It also has a lifting and conveying mechanism (25), the conveyor elements (27, 28) of which can be raised and lowered below the conveyor plane (21) so that the conveyed item (3) can be picked up from the first conveyor unit (4; 11) and transferred onto one of the other conveyor units (5, 6) without jamming. A first positioning mechanism (44) for the raisable and lowerable brake mechanism (35) and a second positioning mechanism (45) for raising and lowering the lifting and conveying mechanism (25) are mechanically coupled in displacement and are linked to one another by a common first drive system (46) only.

### BACKGROUND OF THE INVENTION

1. Field of the invention

The invention relates to a system for transferring conveyed items piece by piece between a first conveyor unit and at least one other conveyer unit extending transversely or at an angle thereto, whereby the conveyed item can be transported on a substantially horizontal conveyor plane, which conveyor plane is defined either by at least two conveyor elements of the first conveyor unit spanning the transfer system or by separate conveyor elements of a first conveyor unit disposed directly on the transfer system.

2. The Prior Art

Many types of transfer systems for transferring single-piece conveyed items between conveyor units extending at an angle to one another are known from the prior art. In order to be able to transfer these conveyed items, e.g. goods, packages, workpieces, workpiece holders or so-called shelves from one conveyor track to the next, the feed rate of the conveyed item usually has to be reduced in the corner or cross-over region. In order to satisfy today's production requirements, items are conveyed at relatively high speeds and then have to be slowed down again at such transfer systems so as not to cause damage either to the conveyed item or the mechanics of the transfer system. In the case of conveyor units operating with low useful loads, shock absorbers or so-called stoppers are used, which stop the conveyed item either directly and abruptly or by absorbing the impact. Such stopper systems are disclosed in patent specifications DE 196 00 266 C2 or DE 198 32 416 A1, for example. Such stopper systems are also used when conveying heavier items of 300 kg, for example, but are somewhat bigger and more complex in order to provide a more effective damping action. Their structure is relatively complex in such instances. The cost of such stoppers and the regular maintenance required by them are also not satisfactory. Furthermore, if using stopper mechanisms of this type, the conveyed items have to be decelerated and stopped within relatively short delays, which places a high degree of strain on the stopper device itself as well as on any other mechanism used for the conveyor system. In addition, the damping action of such stopper devices can not be adapted to a broad range of weights of conveyed items without overcoming certain problems and at great expense.

### SUMMARY OF THE INVENTION

The underlying objective of the present invention is to propose a transfer system or what is referred to as a node module for branched conveyor systems, by means of which conveyed items can be decelerated within a short time as they arrive and transferred to a transversely extending conveyor unit, without the need for a complex electrical control system or complex stopper elements for the conveyed items.

This objective is achieved by the invention due to the fact that a brake mechanism is provided which can be raised and lowered above and below the conveyor plane, so that it can be selectively placed in and out of frictional contact with a bottom face of the conveyed item, and a lifting and conveying mechanism is provided, the conveyor elements of which can be raised and lowered above and below the conveyor plane in order to transfer the conveyed item from the first conveyor unit and pass it to one of the other conveyor units without jamming, for which purpose a first positioning mechanism enabling the brake mechanism to be raised and lowered and a second positioning mechanism for raising and lowering the lifting and conveying mechanism are mechanically coupled in displacement and are linked by a common, first drive mechanism only. The advantage of this transfer system proposed by the invention is that the speed at which the conveyed item is being transported can be decelerated in a specific manner by means of the selectively activatable and deactivatable brake mechanism, i.e. the raisable and lowerable brake mechanism, by means of a sliding friction that is measured accordingly and its momentum can be at least partially absorbed via the brake mechanism as a result. This prevents the conveyed item from being stopped abruptly or colliding in the region of the transfer system, thereby reducing stress on the individual components of the transfer system to within load limits which can be relatively easily controlled. Especially when working with conveyed items of relatively high weights, for example more than 50 kg, the conveyed items can be decelerated and damped softly but still within a short period. Also of advantage is the fact that the lifting and conveying mechanism for the conveyed items to be transferred is specifically able to transfer the conveyed items to a transversely extending conveyor unit without causing jamming or faults because the conveyed items are high enough above the transversely extending components of the so-called incoming or longitudinal conveyor and can be transported onwards and transferred with virtually no resistance. This is conducive to achieving lower transfer times and higher conveyance speeds. Also of particular advantage is the fact that the displacement mechanisms, in particular the positioning mechanisms for the brake mechanism and the lifting and conveying mechanism, are coupled in displacement, which means that initiation and halting of the motions of the brake mechanism and the raising and lowering function of the lifting and conveying mechanism can be synchronised so as to be simultaneous. In addition, the mechanical coupling of the motion imparts a kinematic motion to the brake mechanism relative to the lifting and lowering function of the lifting and conveying mechanism that is accurately repeatable. Any ,,drifting apart” or ,,wandering” of the motion sequences of the brake mechanism relative to the lifting and conveying mechanism such as might otherwise occur when using electrical sequence control systems under certain circumstances can be virtually ruled out in the case of the design proposed by the invention. In view of the fact that the positioning movements of the brake mechanism and the lifting and conveying mechanism are initiated and halted by a single drive system, the individual motion sequences at the transfer system proposed by the invention can be simplified considerably in terms of control technology.

Advantages are also to be had from another possible embodiment of the transfer system, in which the first conveyor system unit has circulating conveyor elements, in particular conveyor chains or conveyor belts, spaced apart from one another forming an endless loop in the conveyor plane, since this makes it possible to bridge even long conveyor runs without any difficulty whilst keeping the amount of noise generated low.

A transfer system in which the conveyor elements of the lifting and conveying mechanism are provided in the form of a plurality of conveyor rollers, the rotation axes of which extend parallel with the conveying direction of the first conveyor system, can easily be integrated between the two conveyor tracks of the first conveyor unit to enable the conveyed items to be transferred to another transversely extending conveyor unit. Another advantage is that a support surface of relatively generous dimensions can be provided for the conveyed items, which will help to ensure that the conveyed item can be reliably lifted and transported transversely.

In another embodiment of the transfer system, the conveyor rollers are mounted on a common support frame of the lifting and conveying mechanism, which means that all the conveyor rollers of the lifting and conveying mechanism can be raised and lowered uniformly.

Also of advantage are other embodiments of the transfer system in which a drive mechanism for the conveyor rollers is secured tot he support frame and the drive mechanism is linked in displacement to a plurality of conveyor rollers via a chain or belt drive, because the drive elements affording the conveying function of the lifting and conveying mechanism are displaced with the lifting frame or lifting table, thereby dispensing with the need for complex systems to apply longitudinal compensation and bridge variable distances.

In another embodiment of the transfer system, the first drive mechanism has an electric motor driving in one direction, which means that the control system used for the transfer system can be of a much simpler design than would be the case if actuators were needed to reverse the drive direction of the drive mechanism.

In one advantageous embodiment of the transfer system, the first drive mechanism has a self-inhibiting gear system, a brake motor or a brake-holding device which can otherwise be activated if necessary for the positioning mechanisms of the brake mechanism and the lifting and conveying mechanism, which means that the load, in particular the conveyed goods, can also be held at a desired high level even when the drive mechanism is switched off without having to be supported by conveyor units adjoining the transfer system or alongside the transfer mechanism which do not have a facility to vary their transport level, dispensing with the need for any load-bearing support thereon.

As a result of the advantageous design of the transfer system in which the first drive mechanism is coupled with the positioning devices in displacement via a crank drive or a crank gear arrangement or a linking drive, a drive mechanism can be used which drives in a rotary motion, which is then converted into a translating or reversing pivoting motion.

In one design of the transfer system, the brake mechanism and the lifting and conveying mechanism start in initial or non-operating positions underneath the conveyor plane and are returned to these initial or non-operating positions after a complete rotation of a crank wheel or a crank arm of the crank drive or linking drive, which advantageously makes activation of the drive mechanism particularly simple. Within such a specifically defined operating cycle, the brake mechanism is activated and deactivated again whilst the lifting and conveying mechanism is simultaneously raised and lowered.

In another design of the transfer system, the positioning mechanisms are provided in the form of at least one rotatably mounted swing lever, which means that with very little effort, any jamming or bending such as can occur with linear guides can be prevented whilst still obtaining the requisite lifting and positioning widths without difficulty.

In another advantageous embodiment of the transfer system, the swing lever has two positioning arms spaced apart and offset from one another at an angle within a pivot plane and/or one positioning arm coupled in displacement with the brake device or a brake element, and the other positioning arm is coupled in displacement with the lifting and conveying mechanism, in which case the motion characteristics and the positioning width of the brake mechanism can be set so as to be different from the motion characteristics and positioning width of the lifting and conveying mechanism. In particular, allowance can be made for the requisite sequence of motions and adjustment made for the opposing relative movement between brake device and lifting and conveying mechanism during individual phases in a particularly simple and reliable manner.

In another embodiment of the transfer system, the swing lever is of a three-armed design with a drive arm and two positioning arms, thereby enabling the requisite torque to be transmitted to the swing lever without difficulty, securing an effective motion coupling with the drive mechanism.

The design of the transfer system in which the drive arm is linked to the crank drive or linking drive, in particular the coupling rod thereof, in an articulated arrangement provides a simple and relatively maintenance-free linkage, obviating the need for linear guides which are susceptible to heavy wear.

With the embodiment of the transfer system in which the drive arm and the two positioning arms are attached to a common bearing shaft, the motion characteristics of the lifting and conveying mechanism is virtually pre-programmed and the system is capable of transmitting high torques and forces.

In another advantageous embodiment of the transfer mechanism, the two positioning arms are disposed at a distance apart from one another in the longitudinal direction of a pivot axis of the bearing shaft, securing another adjustment or pivoting range for the bearing shaft and positioning arms even if the position arms are disposed adjoining additional motion-transmitting elements.

In another advantageous embodiment of the transfer system, two oppositely lying end regions of the brake mechanism, in particular a brake bar, co-operate respectively with a first positioning mechanism, which provides a reliable system for lifting and decelerating high conveyance loads. This also dispenses with the need for slide guides or slide tracks for the vertical motion of the brake mechanism.

In another embodiment of the transfer system, the two oppositely lying end regions of the bearing frame for the lifting and conveying mechanism respectively co-operate with a second positioning mechanism, obviating the need for slide guides or slide tracks for raising and lowering the lifting and conveying mechanism. Moreover, even when carrying higher loads or conveying heavier items, the lifting and conveying mechanism is able to effect a precise lifting and lowering motion without having to overcome any forces and can do so for long periods of time without faults.

As a result of another embodiment of the transfer system, in which the mutually spaced apart first positioning mechanisms are linked in displacement via a dimensionally stable element or a brake element of the brake mechanism and/or the mutually spaced second positioning mechanisms are linked in displacement via the support frame, a coupled motion is achieved in a simple manner between the mutually spaced positioning mechanisms without having to provide separate or additional coupling elements.

In one embodiment of the transfer system, the bearing shaft is rotatably mounted on a base frame or sub-frame or support frame of the transfer system and the distal end regions of the bearing shaft respectively co-operate with a bearing mechanism secured to the base frame or sub-frame or support frame, thereby producing a stable and fixed rotary bearing for the bearing shaft and the swing lever and positioning arms.

In another embodiment of the transfer system, a combined vertical and horizontal motion is effected in a simple manner by the brake mechanism, in particular the brake bar thereof, and the lifting and conveying mechanism via the rotatably mounted positioning mechanism, advantageously obviating the need for linear guides and slide tracks which are susceptible to relatively heavy wear and which also run the high risk of jamming and bending.

As a result of the advantageous embodiment of the transfer system in which the brake mechanism is displaced, in particular the brake bar thereof, the positioning mechanism is shifted into its active position above the conveyor plane, in the vertical direction perpendicular to the conveyor plane, as well as in the horizontal direction in the feed direction of the first conveyor unit, and a conveyed item picked up by the brake mechanism can be continuously decelerated and caught in a virtually damped action by the arcuate motion in the feed direction. In particular, conveyed items can be caught rapidly but relatively softly as they arrive at the transfer system. The active motion of the brake mechanism in the feed direction in which a conveyed item is to be decelerated also reduces the loads acting on the transfer system.

In another advantageous embodiment of the transfer system, a stop element for the conveyed goods is provided parallel with the conveying direction of the lifting and conveying mechanism, which means that conveyed goods that have been only partially decelerated or slowed can be stopped at a specific position relative to the transfer system in a defined manner and on an accurate repeatable basis and at least partially aligned in a desired orientation. Since the conveyed item has been slowed down before hand, the impact energy which has to be absorbed by the stop element is already reduced, which is gentler on the components of the transfer system and/or the conveyed items.

In this connection, another embodiment of the transfer system has advantages because the stop element is attached to the bearing frame of the lifting and conveying mechanism and projects beyond its conveyor plane, which constitutes a simple means of providing a stop element that can be activated and deactivated as and when necessary, and its activation and deactivation can advantageously be combined with the raising and lowering function of the lifting and conveying mechanism.

It is also of particular advantage if the brake mechanism, in particular at least a brake bar thereof, is displaced in the vertical direction perpendicular to the conveyor plane as well as in the horizontal direction towards the stop element when the positioning mechanism is displaced into its active position, because this means that the brake mechanism is also able to perform an active aligning function whereby the decelerated conveyed items are actively forced or pushed against the stop element, thereby providing a relatively accurate and reliable alignment of conveyed items that have assumed a crooked angle or twisted as they arrive. This feature is also conducive to achieving high feed or conveyance rates.

As a result of the alternative embodiment of the transfer system in which the stop element is disposed in an end region of the brake mechanism relative to the conveying direction of the first conveyor system, the stop mechanism can be selectively activated and deactivated because it can be raised and lowered via the brake mechanism as and when necessary.

Due to the specific design of the transfer system in which an end of a positioning arm of the positioning device for the brake mechanism spaced radially apart from the pivot axis or bearing shaft can be displaced, starting from a first bottom dead centre through a top dead centre to another bottom dead centre and vice versa, the brake mechanism can be transferred, starting from a first level, to a relatively higher level and then to another lower level without having to reverse the motion of the drive, in particular the drive mechanism. In particular, this feature advantageously affords a simple means whereby the brake mechanism can effect both a lifting and a lowering motion, even if using a one-way driving motion.

The drive mechanism can be activated in a particularly simple manner due to the advantageous dimensioning of the transfer system, whereby the end of the positioning arm travels a displacement path starting from a first bottom dead centre through a top dead centre and on to another bottom dead centre after a half rotation of the crank drive, in particular the crank wheel thereof, and after a full rotation of the crank drive returns to the first bottom dead centre. In particular, this means that there is no need to reverse the direction of rotation in order to run a complete operating cycle of the brake mechanism and perform the raising and lowering function of the lifting and conveying mechanism at the same time. On completion of an operating cycle of this type, the transfer system is operational again and ready to transfer another conveyed item between two conveyor units extending at an angle to one another.

The motion of the positioning mechanism and the brake mechanism can be forcibly coupled in a particularly stable manner that will require no maintenance due to the fact that the end of the positioning arm is coupled in displacement with the brake mechanism, in particular a brake element thereof, via an articulated link. This specifically ensures that the brake mechanism is actively lifted and activated and actively lowered and deactivated.

As a result of the advantageous embodiment of the transfer system in which a length of the positioning arm for the brake mechanism is of a longer dimension than a length of the positioning arm of the lifting and conveying mechanism, the positioning width or positioning path for the brake mechanism can be selected so as to be bigger than the stroke height or positioning width of the lifting and conveying mechanism.

It is also of particular advantage if the positioning arm for the brake mechanism is more steeply oriented by reference to its pivot plane, in particular if it lies close to a top dead centre of its pivoting motion when pivoted about the pivot axis, than the positioning arm used for the lifting and lowering function of the lifting and conveying mechanism, because as the positioning arm pivots in one direction it imparts a lifting and lowering movement to the brake mechanism, whilst the lifting and conveying mechanism is continuously raised. In other words, the brake mechanism effects a two-way vertical motion whereas the lifting mechanism is raised or lowered in one direction. This advantageously means that when the lifting and conveying mechanism is in the highest position, the brake mechanisms or brake bars are released from the conveyed items again in readiness for the transverse feed to be initiated again without obstruction and braking. The special kinematics of this lever action therefore provides a simple means whereby the load of the conveyed items can be transferred from the brake mechanism to the lifting and conveying mechanism. What this achieves in particular is that during the lifting motion of the lifting and conveying mechanism, the brake mechanism is lowered again with effect from a certain position, causing the conveyed items to be transferred from the brake mechanism to the lifting and conveying mechanism. The angle subtended by the two positioning arms during this action is less than 90°.

Finally, another alternative embodiment for the transfer system is one in which a stop element for the conveyed items is provided in an end region of brake surfaces or brake bars of the brake mechanism, by reference to the direction of conveyance—arrow—of the first conveyor unit, the advantage of which is that the conveyed items are forcibly stopped and brought to a standstill in the end region of the available braking or deceleration path.

### BRIEF DESCRIPTION OF THE DRAWINGS

The invention will be explained in more detail below with reference to embodiments illustrated in the appended drawings.

Of these:

FIG. 1 is a perspective diagram of a transfer system or a so-called node module for a branched conveyor system, as proposed by the invention;

FIG. 2 is an exploded diagram of the transfer system illustrated in FIG. 1;

FIG. 3 is a plan view of the transfer system illustrated in FIG. 1;

FIG. 4 is a section of the transfer system illustrated in FIG. 1 through line IV-IV indicated in FIG. 3;

FIG. 5 is an end-on view of the transfer system illustrated in FIG. 1 in the direction of arrow V indicated in FIG. 3;

FIG. 6 is a section of the transfer system illustrated in FIG. 1 through line VI-VI indicated in FIG. 5, with the brake mechanism deactivated and the lifting and conveying mechanism inactive or lowered;

FIG. 7 depicts the transfer system illustrated in FIG. 6, with the brake mechanism emerging above the conveyor plane in the process of being activated and with the lifting and conveying mechanism still inactive;

FIG. 8 depicts the transfer system illustrated in FIG. 7, with the conveyed item above the conveyor plane of the conveyor unit and the brake mechanism deactivated;

FIG. 9 is a plan view of one possible embodiment of a conveyor system with several transfer systems as proposed by the invention.

### DETAILED DESCRIPTION OF PREFERRED EMBODIMENTS

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc,. relate to the drawing specifically being described and can be transposed in terms of meaning to a new position when another position is being described. Individual features or combinations of features from the different embodiments illustrated and described may be construed as independent inventive solutions or solutions proposed by the invention in their own right.

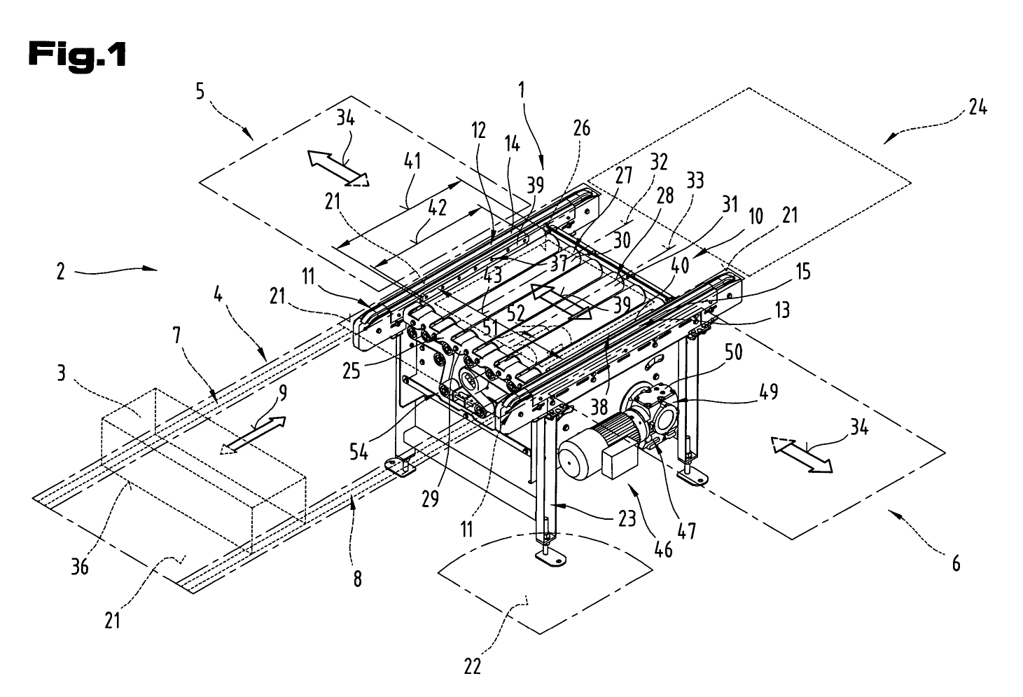

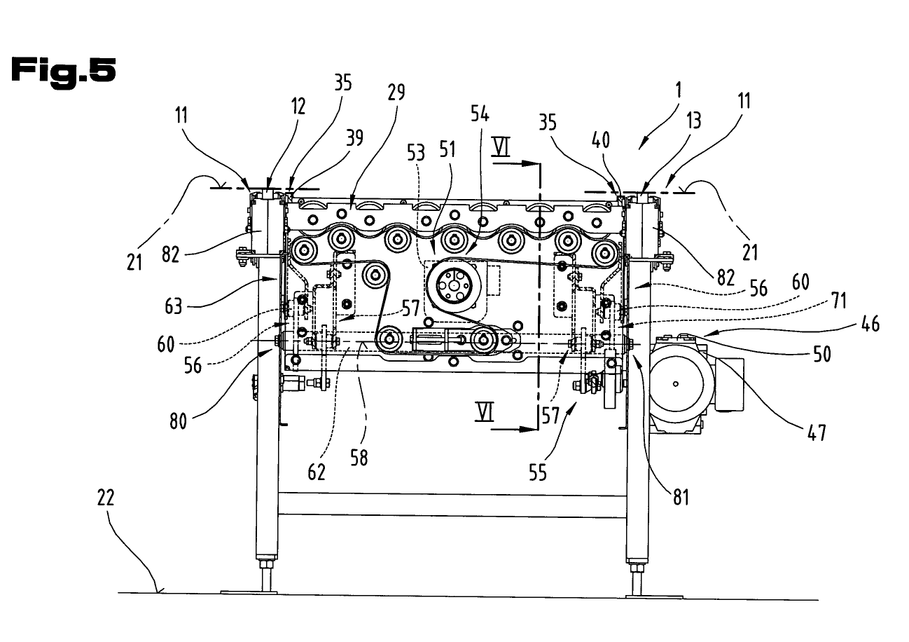

FIGS. 1 to 5 illustrate a preferred embodiment of the transfer system 1 proposed by the invention. This transfer system 1 may be an individual element or module in a more or less complex transport and conveyor system for conveying items 3 piece by piece. The individually conveyed items 3 might be parcels, containers, workpiece holders or workpieces, for example, which have to be moved within the conveyor system 2 by means of several conveyor units 4, 5, 6 to different respective desired or required positions. The individual sequences which take place in this branched conveyor system 2 are at least partially automated, for which purpose a central control system or several electric or electronic control systems are provided.

The transfer system 1 may therefore also be described as a node module, and is either a separate structure or alternatively may at least partially incorporate upstream and downstream conveyor units 4 to 6 and use individual elements and functions of co-operating units. For example, a conveyor unit 4 co-operating with—in particular upstream of—the transfer system 1 may be designed so that its conveyor elements 7, 8 for the conveyed item 3 extend continuously through and into the transfer system 1, as indicated by dotted-dashed lines. In particular, at least two conveyor elements 7, 8 for the conveyed items 3 extend at least as far as the oppositely lying sides or peripheral region 10 of the transfer system 1 by reference to the feed direction—arrow 9—of the upstream conveyor unit 4.

Instead of this “joint use” of functional elements of an upstream or cooperating conveyor unit 4, it would also be possible, within the scope of the invention, to provide a structurally separate conveyor unit 11 alongside the transfer system 1 to enable the conveyed items 3 to be moved in the feed direction—indicated by arrow 9—in at least one direction, as indicated by the conveyor unit 11 shown in solid lines in FIGS. 1 to 5. This being the case, an upstream or co-operating conveyor unit 4 adjoins the conveyor unit 11 provided directly alongside the transfer system 1. The changeover between these conveyor units 4 and 11 should be operated as far as possible without holes and gaps and preferably steplessly, to enable an uninterrupted transfer of the conveyed items 3 from the conveyor unit 4 to the conveyor unit 11 and/or vice versa. The conveyor elements 12, 13 of this conveyor unit 11 may be of the same type as or different from the conveyor elements 7, 8 of the conveyor unit 4. Preferably, the at least two conveyor elements 12, 13 of the conveyor unit 111 are endless and are provided in the form of an endless loop, in particular as conveyor chains or conveyor belts 14, 15. These belt-, chain- or band-type conveyor elements 12, 13 are spaced at a distance apart from one another transversely to the feed direction—arrow 9—and preferably form a so-called two-track conveyor. Instead of the preferred two-track conveyor, it would naturally also be possible to provide a three-track or multi-track conveyor or a broad-belt conveyor, to enable conveyed items 3 that are relatively flexible or not particularly dimensionally stable to be transported, for example.

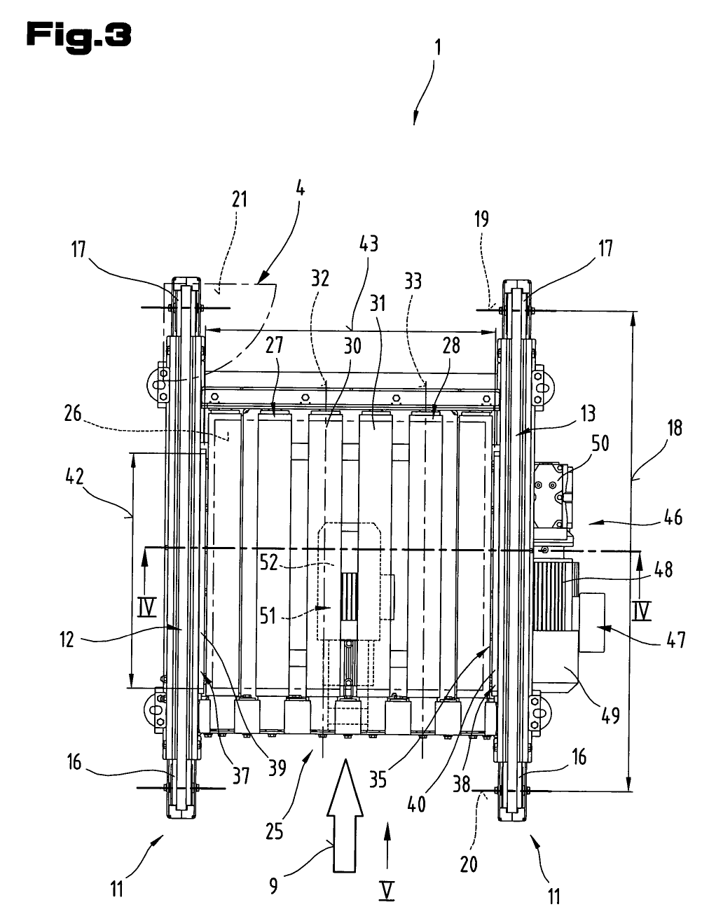

A distance or a track width between the band-type or belt-type conveyor elements 12, 13 will essentially depend on the dimensions and properties of the conveyed items 3 to be transported. As may best be seen from FIG. 3, these conveyor elements 12, 13 circulate in a guided arrangement about mutually spaced return pulleys 16, 17. A distance 18 between the rotation axes 19, 20 of two return pulleys 16, 16 coupled with one another accordingly essentially corresponds to a maximum conveyor length of this preferably two-track conveyor unit 11 based on conveyor belts 14, 15.

Naturally, it would also be possible for the conveyor elements 12, 13 of the conveyor unit 11 to be provided in the form of at least two but preferably a plurality of rollers arranged in a row, which together will then constitute the desired conveyor length for the conveyed items 3. In particular, instead of the belt conveyor illustrated, it would be possible to use a so-called roller conveyor to feed along the conveyed item 3 towards and away from the transfer system 1. Likewise, it would also be possible to use a combination, in which case the conveyor unit 11 might be a roller conveyor and the conveyor unit 4 adjoining or virtually docking with it might be a belt conveyor. Another conceivable option would an embodiment with the reverse of the above.

The conveyor elements 12, 13 of the conveyor unit 11 and/or the conveyor elements 7, 8 of the conveyor unit 4 define a substantially horizontal conveyor plane 21, on which the conveyed items 3 are transported. This conveyor plane 21 is disposed at a certain distance above a standing plane 22 or floor level. The conveyor plane preferably lies more or less at hip height above a floor level or above the standing plane 22 of the conveyor system 2 and the transfer system 1. The height level of this conveyor plane 21 may be defined and fixed by a sub- or support frame 23 for the components of the transfer system 1, for example. Alternatively, the transfer system 1 proposed by the invention might not have any sub- or support frame 23 at all for supporting the transfer system 1 on the standing plane 22 but instead the relevant functional components of the transfer system 1 might be mounted or suspended in a free-standing arrangement on at least one of the upstream or downstream conveyor units 4 to 6.

The conveyor plane 21 for the conveyed items 3 defined by the conveyor elements 7, 8 and 12, 13 is preferably fixed or pre-set, i.e. is constant during operation of the transfer system 1 and the conveyor system 2. In the embodiment illustrated as an example here, the conveyor elements 12, 13 sit at a fixed height relative to the standing plane 22 due to the framework of the sub- or support frame 23.

Adjoining the transfer system 1 is at least one other conveyor unit 5, 6 extending transversely to the first conveyor unit 4; 11. As indicated by broken lines, it would also be possible to provide an additional straight conveyor unit 24 leading on to the first conveyor unit 4; 11 and connecting with the conveyor unit 4; 11. It would also be conceivable for the conveyor unit 11 to constitute both the upstream conveyor unit 4 and the downstream conveyor unit 24.

The transfer system 1 or so-called node module enables the conveyed items 3 to be transferred unhindered and without jamming from the first conveyor unit 4; 11 to at least one other conveyor unit 5 or 6 extending transversely or at an angle thereto. Accordingly, the transfer system 1 or so-called node module may be used to set up L-, U-, Z- or X-shaped conveyor tracks or conveyor systems 2.

The feed direction of the other conveyor unit 5; 6 usually extends at a right-angle to the feed direction—arrow 9—of the first conveyor unit 4; 11. Alternatively, it would also be possible to provide conveyor tracks subtending an angle of less than 90°, in which case the transfer system 1 would be structurally adapted to these so-called acute-angled and obtuse-angled crossing or intersecting angles of the conveyor units 4; 11 and 5; 6.

The transfer system 1 has a lifting and conveying mechanism 25 which is disposed and conveys transversely to the feed direction—indicated by arrow 9—by means of which a conveyed item 3 can be transferred from the conveyor unit 4 or 11 to one of the conveyor units 5, 6. Provided care is taken to ensure that a conveyor level of the conveyor unit 5 or 6 is at least slightly higher than the conveyor plane 21 of the conveyor unit 4; 11, it will be also possible for conveyed items 3 to be transferred via the transfer system 1 from the conveyor units 5 and 6 to the conveyor unit 4; 11 or 24, by making use of the height adjustability of the lifting and conveying mechanism 25 and the fact that it can be lowered.

The lifting and conveying mechanism 25 constitutes a so-called lifting and conveying table, the conveyor plane 26 of which, indicated by broken lines, is variable in height. It is preferable to used a combined structure for the lifting and conveying mechanism 25, i.e. the conveyor elements 27, 28 of the lifting and conveying mechanism 25 are mounted on a common, height-adjustable bearing frame 29. This bearing frame 29 for the conveyor elements 27, 28 can be raised and lowered relative to the sub- or support frame 23 and relative to the conveyor plane 21 of the conveyor unit 4; 11 as and when necessary, thereby affording the lifting and conveying function of the lifting and conveying mechanism 25. As a result of this lifting and conveying function of the lifting and conveying mechanism 25, the conveyed items 3 can be transferred without jamming and unhindered from the first conveyor unit 4; 11 to one of the other transversely extending conveyor units 5; 6. Especially if the lifting and conveying mechanism 25, and in particular its conveyor plane 26, lies at least slightly below or optionally on the same level as the conveyor plane 21, a specific conveyed item 3 on the conveyor unit 4 or 11 can be picked up by the transfer system 1. In particular, if the conveyor plane 26 of the lifting and conveying mechanism 25 is on the same level as the conveyor plane 21, preferably at least slightly below the conveyor plane 21, the conveyed item 3 can be moved and transported from the conveyor unit 4 or 11 onto or across the lifting and conveying mechanism 25. When a conveyed item 3 which has to be transferred is located above the lifting and conveying mechanism 25 and the conveyed item 3 is sitting on the conveyor plane 26, at least the lifting function of the lifting and conveying mechanism 25 can then be activated and the conveyed item 3 preferably lifted above the conveyor plane 21 of the conveyor unit 4; 11. Amongst other things and depending on the conveyed item 3 and the conveyor unit 4; 11 and/or the conveyor unit 5, 6, it may be sufficient to raise the conveyor plane 26 of the lifting and conveying mechanism 25 to approximately the same level as the conveyor plane 21 of the conveyor unit 4; 11 in order to transfer the conveyed item 3 from the lifting and conveying mechanism 25 up over the conveyor unit 4; 11 as far as the conveyor unit 5 or 6. To this end, the conveyor plane 26 of the lifting and conveying mechanism 25 should be raised at least far enough to ensure that the conveyed item 3 does not run onto parts of the conveyor unit 4; 11 or the conveyor unit 5 or 6 in such a way that it blocks onward transport at this junction point between the individual conveyor tracks. The same would apply if the conveyed items 3 were being transferred from the conveyor unit 5 or 6 to the conveyor unit 4; 11 or 24.

The conveyor elements 27, 28 of the lifting and conveying mechanism 25 are preferably provided in the form of at least two, in particular a plurality of conveyor rollers 30, 31. The conveyor rollers 30, 31 define the conveyor plane 21 and form a so-called roller run on the lifting and conveying mechanism 25. The rotation axes 32, 33 of these conveyor rollers 30, 31 extend parallel with the feed direction—indicated by arrow 9—of the first conveyor unit 4; 11. By reference to the conveyor unit 5, these rotation axes 32, 33 of the row of parallel conveyor rollers 30, 31 extend transversely to the feed direction—indicated by arrow 34—of the conveyor unit 5 or. 6. Accordingly, the lifting and conveying mechanism 25 is preferably provided as a so-called roller lifting table or a height-adjustable roller run. As an alternative, it would also be conceivable for the conveyor elements 27, 28 of the lifting and conveying mechanism 25 to be provided in the form of an at least two-track belt or chain conveyor or a relatively wide band conveyor with an endlessly circulating conveyor belt.

The transfer system 1 proposed by the invention also has a brake mechanism 35 which can be raised and lowered and is used for conveyed items 3 which have to be transported and switched to different conveyor directions 3. By means of this brake mechanism 35, a conveyed item 3 being transported in the direction towards the transfer system 1 can be at least decelerated and slowed down. In particular, this brake mechanism 35 will, if necessary, enable a conveyed item 3 being transported on the conveyor unit 4; 11 at a specific predefined speed to be decelerated within a specific delay path alongside the transfer system 1 or optionally brought to a standstill via the brake mechanism 35 at the transfer system 1 and above the lifting and conveying mechanism 25. The essential point about this is that the feed rate of the conveyor unit 4; 11 can be kept unchanged and it will not have to be stopped or slowed down, which means that other conveyed items 3 being transported on the conveyor unit 4; 11 do not have to be held back. In particular, the conveyor unit 4; 11 can continue to be operated at a predefined, continuous speed and because the brake mechanism 35 can be activated as and when necessary, a specific conveyed item 3 can be selectively decelerated and stopped in the region of the transfer system 1 or in the region of the conveyor plane 26. The brake mechanism 35 can be selectively activated and deactivated for this purpose, in which case the brake mechanism 35 is lowered or raised as and when necessary above and preferably slightly below the conveyor plane 21 or to the same level as the conveyor plane 21. When the brake mechanism 35 is in the active position, it or at least its braking means, projects at least slightly above the conveyor plane 21 of the conveyor unit 4; 11 so that it establishes a friction contact with the bottom face 36 of a conveyed item 3 as it is carried along. If the brake mechanism 35 or at least one brake element 37, 38 applying the braking action is positioned below the level of the conveyor plane 21 or substantially on the same level as the conveyor plane 21, this brake mechanism 35 is then inactive because its brake element 37, 38 is not at all in contact or is so to only a minimal or negligible degree, with the bottom face 36 of a conveyed item 3 being transported in the region of the transfer system 1.

The brake elements 37, 38 of the selectively activatable and de-activatable brake mechanism 35 are preferably provided in the form of elongate brake elements 37, 38, in particular by means of at least one, preferably at least two brake bar(s) 39, 40. These bar-shaped brake elements 37, 38 are aligned substantially parallel with the feed direction—indicated by arrow 9—of the first conveyor unit 4; 11 and, depending on the desired deceleration curve or braking action and/or braking characteristic to be obtained, preferably extend more or less across a width 41 of the lifting and conveying mechanism 25. A length 42 of the brake bars 39, 40 therefore essentially corresponds to the width of the conveyor plane 26 of the lifting and conveying mechanism 25. This ensures that a conveyed item 3 running on to the brake elements 37, 38 or onto the brake bars 39, 40 of the brake mechanism 35 will be transferred in a safe and stable manner without tipping over and passed on to the lifting and conveying mechanism 25, in particular it is conveyor elements 27, 28, with its load supported. A length 42 of the brake bars 39, 40 is preferably 0.7 to 1.3 times a width 41 of the lifting and conveying mechanism 25 or the conveyor plane 26 thereof.

The brake bars 39, 40 are preferably attached to the board- or ram-type brake elements 37, 38 in a manner which allows them to be replaced. For example, a screw connection may be provided between the brake bars 39, 40 and the brake elements 37, 38. The brake action or braking characteristics of the brake mechanism 35 can be adapted to the respective conditions and requirements in a simple manner, merely by exchanging or replacing the brake bars 39, 40. In particular, depending on the material used for the brake bars 39, 40, the coefficient of friction of the brake surfaces can be varied and adapted to suit different conditions. The materials and braking action of the brake bars 39, 40 will depend on the properties or friction of coefficient of the bottom face 36 of whatever item 3 has to be conveyed, for example. The fact that the brake bars 39, 40 can be dismantled from and mounted on the brake mechanism 35 by means of coupling devices or screw connections known from the prior art means that worn brake bars 39, 40 can also be rapidly and easily replaced if necessary. The braking action can therefore be adapted by means of a simple selection of the material used for the brake bars 39, 40 or the brake linings, for example.

It is preferable to provide at least two mutually spaced brake elements 37, 38 or brake bars 39, 40 transversely to the braking direction. A distance 43 measured transversely to the feed direction of the conveyor unit 4; 11—arrow 9—between the (outermost) brake bars 39, 40 more or less corresponds to a conveyor length of the lifting and conveying mechanism 25 or a track width of a conveyor unit 4; 11 provided in the form of two-track system. The distance 43 between the brake bars 39, 40 should also be dimensioned so that a conveyed item 3 to be switched, i.e. transported at a right angle on the transfer system 1, can be picked up in a stable manner and without tipping over by the brake bars 39, 40 and its bottom face 36 reliably lifted above the conveyor plane 21 of the conveyor unit 4; 11.

In order to be able to selectively raise and lower the brake mechanism 35 or at least its brake elements 37, 38 above and preferably at least slightly below the conveyor plane 21, the transfer system 1 is provided with a first positioning mechanism 44. A second positioning mechanism 45 is also provided on the transfer system 1 as a means of lifting and lowering the lifting and conveying mechanism 25 and for switching between the lifting and lowering function of the lifting and conveying mechanism 25. These positioning mechanisms 44 and 45 therefore cause the brake mechanism 35 and the lifting and conveying mechanism 25 to be moved and displaced as necessary down below and above the conveyor plane 21.

The essential aspect of this is that the first positioning mechanism 44 and the second positioning mechanism 45 are mechanically coupled in displacement so that when the first positioning mechanism 44 is displaced or activated, the second positioning mechanism 45 is also forcibly moved or displaced with it. This coupled displacement between the first positioning mechanism 44 and the second positioning mechanism 45 may be pre-set so that it is fixed or constant or alternatively it may also be set up to be adjustable. Especially in the case of an adjustable motion coupling between the first and second positioning mechanisms 44 and 45, the motion characteristics of the first positioning mechanism 44 can be varied relative to the second positioning mechanism 45 to suit varied or different conditions as necessary.

The essential aspect of this feature is that the first positioning mechanism 44 for the brake mechanism 35 and the second positioning mechanism 45 for the lifting and conveying mechanism 25 are coupled with one another in displacement, which means that they need to be linked to a common first drive system 46. In other words, the driving and motion energy provided by this first drive system 46 acts on both the first positioning mechanism 44 and on the second positioning mechanism 45 and the brake mechanism 35 is therefore activated and deactivated and the lifting and conveying mechanism 25 raised and lowered from only a single drive source or drive system 46. As a result of the preferably purely mechanically coupled motion between the first positioning mechanism 44 and the second positioning mechanism 45, the motion of the brake mechanism 35 is simultaneous and synchronous with the lifting and lowering motions of the lifting and conveying mechanism 25.

In particular, in a direction perpendicular to the conveyor plane 21 and the lifting and conveying mechanism 25, the brake mechanism 35 also moves in a direction perpendicular to the conveyor plane 21, immediately the drive system 46 is set in motion or activated. At that instant at which the first drive system 46 is halted, the vertical motion of the brake mechanism 35 and the vertical motion of the lifting and conveying mechanism 25, in particular the lifting table, are simultaneously terminated.

The drive system 46 may be provided in the form of an electric, hydraulic or pneumatic linear or rotary drive. For example, the drive system 46 might by a hydraulic or pneumatic piston/cylinder arrangement or an electromagnetic linear motor or any other actuator.

The drive system 46 is preferably an electrically controllable geared motor 47, which is connected to the first positioning mechanism 44 and the second positioning mechanism 45 in a driving and displacing relationship. This drive system 46 or the corresponding geared motor 47 is preferably mounted directly on the transfer system 1, in particular on the sub- or support frame 23. The coupling of the motion between the first positioning mechanism 44 and the second positioning mechanism 45 is preferably purely mechanical, for example obtained by means of lever systems, driver systems, gear mechanisms or similar. The positioning mechanisms 44, 45 themselves are preferably provided in the form of crank drives connected between the drive system 46 and the brake mechanism 35 and the lifting and conveying mechanism 25, as will be explained in more detail below.

An electric motor 48 of the drive system 46 is wired to a control system, not illustrated, and is controlled by it accordingly, i.e. at least switched on and off. It is preferable if this drive system 46 operates exclusively in one direction and it is only necessary for the electric motor 48 to be operated in one direction of rotation. This makes the control technology significantly less complicated because there is no need to provide components or features for reversing the direction of rotation of the drive system 46 or electric motor 48, for example.

This first drive system 46 may optionally have a brake hold mechanism 49 for the positioning mechanisms 44, 45 of the brake mechanism 35 or the lifting and conveying mechanism 25 which can be activated as necessary or is automatically activated. This will prevent an activated brake mechanism 35 or raised lifting and conveying mechanism 25 from dropping under the load of the conveyed item 3 once the driving power of the drive system 46 has been deactivated, for example. This brake hold mechanism 49 may be provided in the form of a self-inhibiting gear system 50, a brake motor, a so-called spring-operated brake or similar, for example. As soon as this brake hold mechanism 49 is activated, it prevents the positioning mechanisms 44, 45 or the brake mechanism 35 and the lifting and conveying mechanism 25 from being displaced in a direction perpendicular to the conveyor plane 21 when the drive system 46 is inactive or the electric motor is deactivated. Consequently, a load lifted via the brake mechanism 35 or its brake bars 39, 40, i.e. a lifted conveyed item 3, and/or a conveyed item 3 lifted via the lifting and conveying mechanism 25 can be reliably maintained in this lifted position or arrangement if the drive for the positioning mechanisms 44, 45 is switched off when they are at any level above the conveyor plane 21.

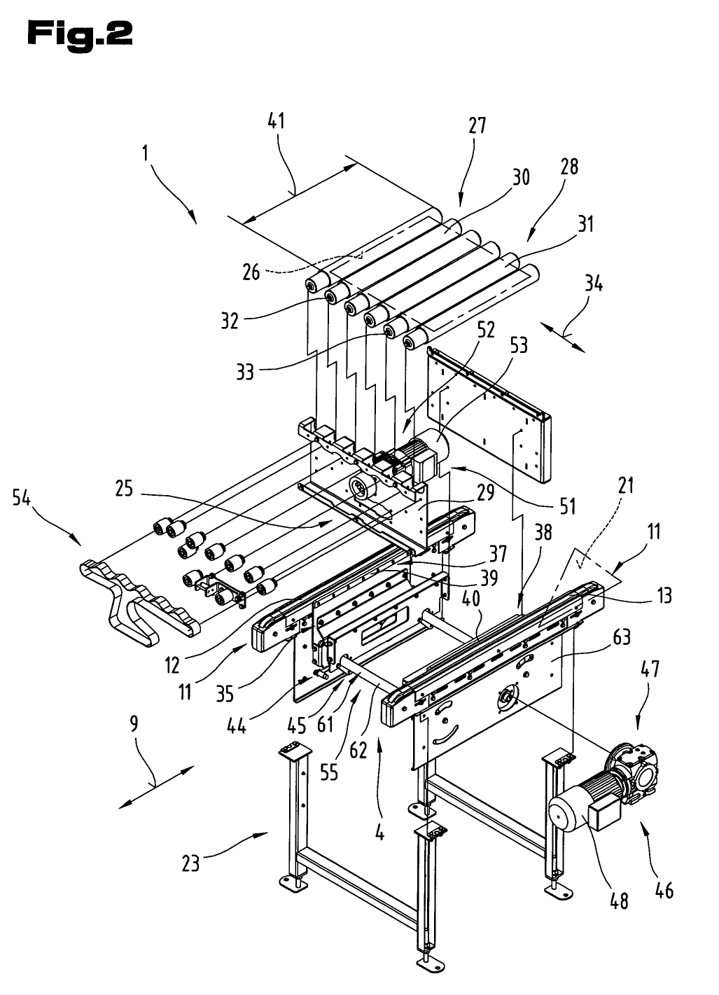

As may be seen most clearly from FIG. 2, another drive system 51 is provided on the transfer system 1 for operating the conveying and transport function of the lifting and conveying mechanism 25. This drive system 51 is preferably mounted on and secured to a part of the vertically displaceable bearing frame 29 of the lifting and conveying mechanism 25. In particular, this drive system 51 is connected to the bearing frame 29 which also supports the conveyor elements 27, 28, in particular the conveyor rollers 30, 31 of the lifting and conveying mechanism 25. This drive system 51, which is preferably provided in the form of a geared motor 52 incorporating an electric motor 53 and a mechanical gear system, is preferably linked via a chain or belt drive 54 in order to displace to a plurality of conveyor rollers 30, 31. As an alternative, it would be conceivable to provide a gear-driven coupling between the drive system 51 and at least some, preferably all of the conveyor rollers 30, 31 of the lifting and conveying mechanism 25. However, a design of this type would mean higher costs and lower tolerances, relatively speaking.

The drive system 51 is connected to an electric control system, not illustrated, by which it is activated in such a way that at least one unidirectional driving motion is generated. If this lifting and conveying mechanism 25 is to be capable of transporting the conveyed item 3 in opposite feed directions—as indicated by arrow 34—the drive system 51 can be controlled by the control system so that it can be reversed, thereby enabling driving motions to be selectively generated in opposite directions.

The positioning mechanisms 44, 45 are essentially provided in the form of a so-called crank drive 55, which converts a preferably unidirectional and rotary driving motion generated by the drive system 46 into a two-directional linear motion or a two-directional vertical motion causing the brake mechanism 35 and lifting and conveying mechanism 25 to be raised and lowered. This crank drive 55 has at least one positioning arm 56, 57 which is rotatably mounted or mounted so as to pivot via the drive system 46. In particular, a positioning arm 56 is mounted so as to rotate about a pivot axis 58, the end 59 of which remote from the pivot axis 58 is linked in a displacing relationship to the brake mechanism 35 and acts on the brake mechanism 35 in order to displace it. Preferably a link is provided between an end 59 of the positioning arm 56 spaced radially at a distance from the pivot axis 58 and the brake mechanism 35 via an articulated connection 60. In other words, the at least one positioning arm 56 for the brake mechanism 35 is forcibly coupled with the brake mechanism 35 or its braking element 37, 38 in displacement. When the positioning arm 56 is pivoted, the brake mechanism 35—driven by the positioning arm 56 as it is pivoted about the pivot axis 58—is forcibly raised or forcibly lowered. Simultaneously, the brake mechanism 35—in particular its brake elements 37, 38 or brake bars 39, 40—is moved slightly in or opposite the feed direction—indicated by arrow 9—of the conveyor unit 4; 11.

In a similar manner, the positioning mechanism 45 for raising and lowering the lifting and conveying mechanism 25 is provided by means of at least one other, preferably separate, positioning arm 57. This other positioning arm 57 for the lifting and conveying mechanism 25 is preferably mounted so that it is able to pivot about one and the same pivot axis 58 as the positioning arm 56 for the brake mechanism 35. Accordingly, a common pivot bearing 61 is preferably provided for the positioning arm 56 and the positioning arm 57. This pivot bearing 61 has a bearing shaft 62 on which the positioning arms 56, 57 are fixed. This bearing shaft 62 defines the pivot axis 58 and remains stationary on a base frame 63 or on the sub- or support frame 23 of the transfer system 1 but is mounted so that it can be displaced in rotation about its longitudinal axis. The bearing shaft 62 and its pivot axis 58 extend transversely to the feed direction—arrow 9—of the conveyor unit 4; 11 and substantially parallel with the conveyor plane 21.

An end 64 of the positioning arm 57 spaced at a distance apart from the pivot axis 58 is coupled in displacement or actively coupled with the lifting and conveying mechanism 25, in particular its bearing frame 29. The end 64 of the positioning arms 57 is preferably coupled with the bearing frame 29 of the lifting and conveying mechanism in displacement via an articulated link 65. This produces a forced coupling of the motion, i.e. when the positioning arm 57 is pivoted, the bearing frame 29 is forcibly raised or lowered in the direction perpendicular to the conveyor plane 21. The bearing frame 29 or the lifting and conveying mechanism 25 simultaneously effects a horizontal motion shorter than the vertical motion, parallel with the feed direction—indicated by arrow 9—of the conveyor unit 4; 11.

Driven by the drive system 46, the two positioning arms 56, 57 are therefore pivoted in a pivot plane 66 extending perpendicular to the conveyor plane 21 and in the direction of the feed direction—indicated by arrow 9. The positioning arms 56 and 57 on the bearing shaft 62 are therefore arranged offset from one another at a defined angle 67 by reference to the pivot plane 66 and are spaced apart from one another by a specific angle of rotation by reference to the pivot axis 58 of the bearing shaft 62. An active or action-related length 68 of the positioning arm 56 is therefore different from a length 69 of the positioning arm 57. The length 68 of the positioning arm 56 for the brake mechanism 35 is preferably greater than a length 69 of the positioning arm 57 for the lifting and conveying mechanism 25, in particular for the lifting mechanism or bearing frame 29.

The two positioning arms 56, 57 offset from one another at a specific angular distance within the pivot plane 66 are preferably connected to the bearing shaft 62 in a fixed or rigid arrangement. Alternatively, it would also be conceivable to connect at least one of the positioning arms 56, 57 to the bearing shaft 62 in an adjustable or linking arrangement as necessary.

Consequently, the positioning arm 56 is coupled with the brake mechanism 35, in particular with at least one of the brake bars 39, 40, in rotation via the articulated link 60. The other positioning arm 57 is connected via the other articulated link 65 to the bearing frame 29 of the lifting and conveying mechanism 25 so that it can rotate and thus forms the lifting mechanism of the transfer system 1.

The bearing shaft 58 additionally has at least one drive arm 70 standing radially out from its pivot axis 58. The driving energy of the drive system 46 is transmitted by means of this drive arm 70 to the bearing shaft 62 and to the positioning arms 56, 57. Alternatively, it would naturally also be possible to use one of the positioning arms 56 or 57 simultaneously as a drive arm 70, in which case one of the positioning arms 56, 57 would additionally be coupled with the drive system 46 in a displacing relationship.

This drive arm 70 is preferably disposed diametrically opposite one of the positioning arms 56, 57 by reference to the bearing shaft 62.

The positioning mechanisms 44, 45 are therefore provided in the form of at least one multi-arm, rotatably mounted swing lever 71. This swing lever 71 has at least two arms insofar as it incorporates at least the positioning arms 56 and 57. However, this swing lever 71, which rotates about the pivot axis 58, preferably has three arms and, this being the case, has the two positioning arms 56 and 57 arranged offset from one another within the pivot plane 66 and a drive arm 70 standing out radially from the pivot axis 58. Instead of providing a separate drive arm 70 on the bearing shaft 62, this drive arm 70 could also be provided by making one of the positioning arms 56, 57 longer. Disc-shaped elements on the bearing shaft 62 would have the same effect as positioning arms 56, 57 and drive arms 70 projecting out from or standing proud of the bearing shaft 62.

The positioning mechanisms 44, 45 are, and in particular the multi-arm swing lever 71 is, preferably coupled with the first drive system 46 in displacement by means of a connecting drive 72. A coupling rod 73 is specifically provided, which links the swing lever 71, in particular the drive arm 70 thereof, to the drive system 46. The drive arm 70 is preferably coupled so as to be displaced by the connecting drive 72, in particular the coupling rod 73 thereof, by an articulated link 74. The drive system 46, in particular the geared motor 47, has a crank wheel 75 or an appropriate crank arm, which is articulatingly linked via another articulated link 76 to the distal or other end of the coupling rod 73. In particular, the crank wheel 75 forms the so-called connecting drive 72 in conjunction with the articulated link 76 to the coupling rod 73. Instead of using the illustrated articulated link 74 for the end of the coupling rod remote from the crank wheel 75 or the crank arm, it would also be possible to provide an articulated joint in an oblong guide to enable the end of the coupling rod 73 to be displaced in a linear rather than arcuate motion.

The embodiment described above may also be provided in the form of a push-crank or a drive operating on the reciprocating shaft principle.

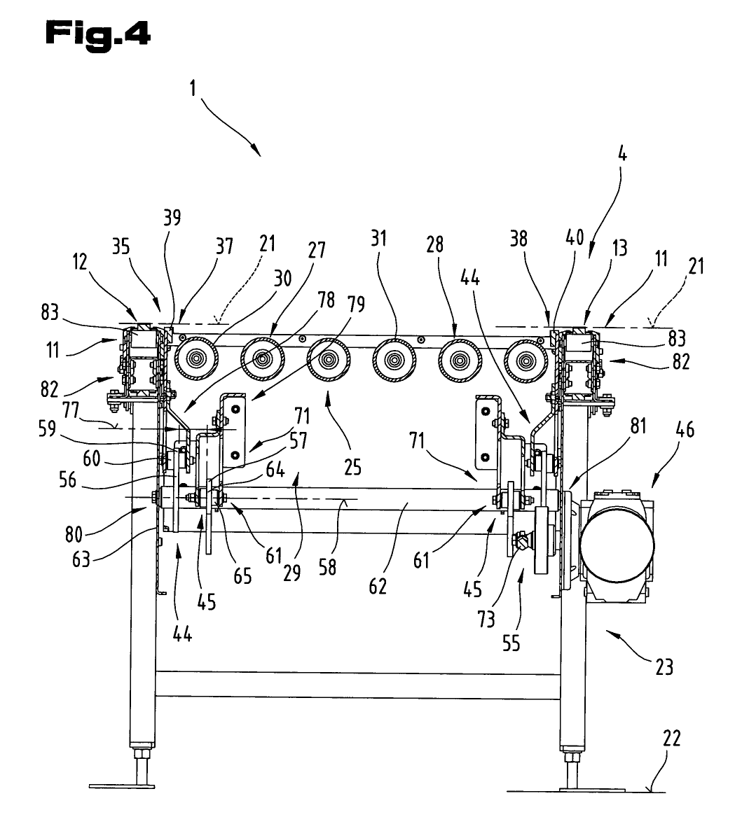

As may be seen most clearly from FIG. 4, the positioning arms 56, 57 are arranged at a distance 77 apart from one another in the longitudinal direction of the pivot axis 58 of the bearing shaft 62. This enables generously dimensioned motion-transmitting members 78, 79 to be used between the positioning arms 56, 57 and their ends 59, 64 disposed radially at a distance from the pivot axis and the brake mechanism 35 and lifting and conveying mechanism 25, in particular the bearing frame 29 thereof. This also enables a relatively wide pivot angle to be obtained for the bearing shaft 62 without the motion-transmitting members 78, 79 obstructing one another. The distance 77 between the positioning arms 56, 57 also means that the articulated connections 60, 65 can likewise be of generous dimensions, thereby providing a displacement mechanism that will require no maintenance for a long time.

As is more clearly illustrated by a comparison of FIGS. 2 and 4, two respective positioning mechanisms 44 and 45 for the brake mechanism 35 and the lifting and conveying mechanism 25 are provided at a distance apart from one another in the longitudinal direction of the bearing shaft 62. Accordingly, a respective positioning mechanism 44 and a respective positioning mechanism 45 is preferably provided in the terminal end regions of the bearing shaft 62.

In a preferred embodiment, the transfer system 1 has a dual or double arrangement for the bearing shaft 62 with the positioning mechanisms 44, 45. In particular, two bearing shafts 62 are mounted provided axially parallel and at a distance apart from one another in the feed direction—arrow 9—on the base frame or on the sub- or support frame 23 of the transfer system 1. Each bearing shaft 62 has two positioning mechanisms 44 each and two positioning mechanisms 45 each. The advantage of this is that at least the lifting and conveying mechanism 25 has a so-called four-point support. However, the brake mechanism 35 is also preferably raised and lowered by means of a four-point bearing. In particular, a positioning mechanism 44 is provided in each of the terminal-side end regions of the board-type or bar-type brake elements 37, 38. Using this four-point or at least-two point bearing for the lifting and conveying mechanism 25 and the brake mechanism 35 imparts strong lifting strength and dimensional stability to components which are not inherently particularly stable, relatively speaking. Advantageously, relatively heavy loads and conveyed items 3 can be manipulated using a transfer system with a relatively low intrinsic weight because the forces or torques which occur are better distributed and can therefore be more reliably absorbed by the brake mechanism 35 and the lifting and conveying mechanism 25. This also minimises bending in the individual components, which might otherwise occur on a repeated basis due to one-sided loads or localised or central loads.

In the distal terminal end regions, the at least one bearing shaft 62 is mounted by means of bearing mechanisms 80, 81, enabling it to rotate. These bearing mechanisms 80, 81 also link the base frame 63 or the sub- or support frame 23 to the terminal end regions of the bearing shaft 62 and thus define the pivot axis 58 for the positioning mechanisms 44, 45 and accordingly, the at least two-armed swing lever 71. The distance between oppositely lying wall parts of the base frame 63 is also maintained via the bearing mechanisms 80, 81, thereby improving the rigidity of the base frame 63.

The drive system 46 is preferably directly coupled with only one of the two bearing shafts 62. The second bearing shaft 62 spaced at a distance apart from the first bearing shaft 62 in the feed direction—arrow 9—and incorporating the positioning mechanisms 44, 45 is preferably coupled with the first bearing shaft in displacement via the brake elements 37, 38 and the bearing frame 29 of the lifting and conveying mechanism 25 only. In other words, the displacement energy is transmitted from the first bearing shaft 62 to the second bearing shaft 62 exclusively via the supporting elements or components of the brake mechanism 35 and the lifting and conveying mechanism 25. The first and the second bearing shafts 62 with their respective swing levers 71 and positioning arms 56, 57 are preferably of identical construction.

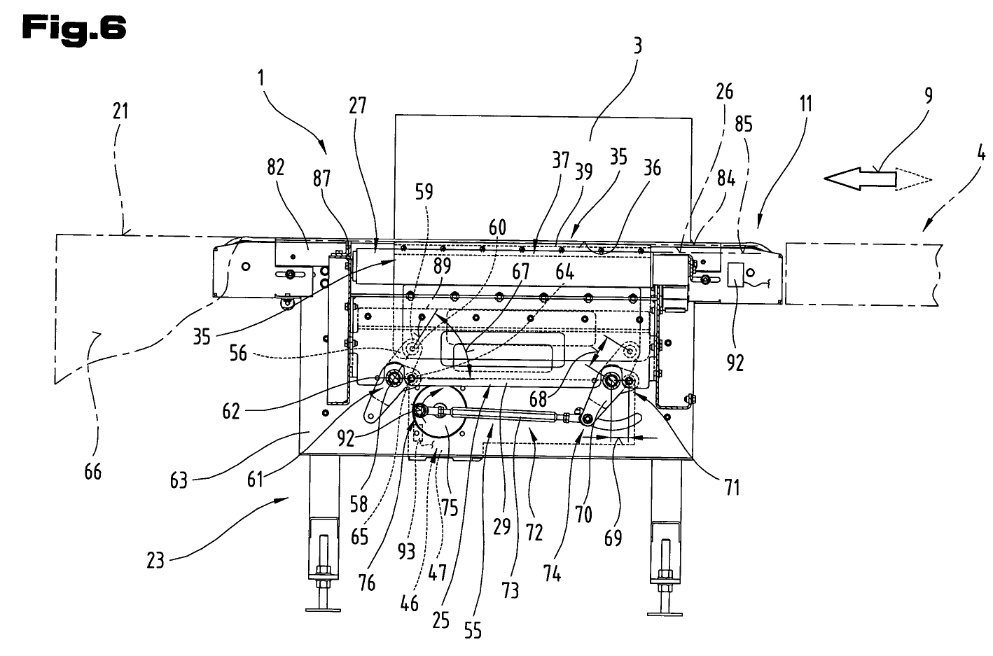

In particular, the motion mechanics of the transfer system 1 are provided by means of a lifting mechanism in a parallelogram arrangement or as double parallel levers for the brake mechanism 35 and the lifting and conveying mechanism 25, as may best be seen from FIG. 6. The pivot axes 58 of the two bearing shafts 62 in this arrangement form the bottom corner points of two parallelograms and the rotation axes of the articulated link 60 and 65 form the top corner points of this double, mechanically coupled parallelogram-kinematic arrangement.

As may best be seen from FIG. 4, the conveyor unit 11 constitutes a continuously extending conveyor unit 4, preferably comprising a two-track belt conveyor. Guided in parallel, the strands of the belt conveyor essentially each consists of a longitudinally extending support element 82, borne in return pulleys 16, 17 for the conveyor element 12, 13 and 7, 8 forming the endless loop at the terminal end regions. Mounted within the conveyor run between these return pulleys 16, 17 several support rollers 83 are provided at a distance apart from one another, on which the bottom face of the belt-type conveyor elements 12, 13 is supported. The belt-type conveyor elements 12, 13 are preferably of a T-shaped design in cross section, thereby imparting improved guiding accuracy and guiding stability to the conveyor unit 4; 11.

Turning to FIGS. 6 to 8, a description will now be given of the procedures and sequences involved in transferring conveyed items 3 piece by piece from the conveyor unit 4; 11 to a transverse conveyor track.

As illustrated in FIG. 6, the transfer system 1, in particular the brake mechanism 35 thereof, is in an initial or non-operating position 84, in which the effective surface, i.e. the brake or friction surface of the brake elements 37, 38, is preferably located at least slightly below the conveyor plane 21. Likewise, the conveyor plane 26 of the lifting and conveying mechanism 25 preferably lies at least slightly below the conveyor plane 21 of the conveyor unit 4; 11. If handling conveyed items 3 with an uneven or stepped bottom face 36, it would also be conceivable for the brake surfaces of the brake mechanism 35 and the support and transport surfaces of the lifting and conveying mechanism 25 to be disposed on the same level as the conveyor plane 21 or even to remain slightly above this conveyor plane 21. In the diagram illustrated in FIG. 6, however, the lifting and conveying mechanism 25 has an initial or non-operating position 85 in which its conveyor plane 26 preferably sits below the level of the conveyor plane 21. The initial or non-operating position 85 of the lifting and conveying mechanism 25 preferably sits slightly lower than the initial or non-operating position 84 of the brake mechanism 35.

When the brake mechanism 35 is in the initial or non-operating position 84, the brake mechanism 35 is at least for the most part inactive. Similarly, the transport function of the lifting and conveying mechanism is basically out of action due to the fact that the conveyor plane 26 of the conveyor elements is lowered to a level below the conveyor plane 21. When the brake mechanism 35 and the lifting and conveying mechanism 25 are in the initial or non-operating positions 84, 85, the conveyor unit 4; 11 is able to move the conveyed item 3 which has to be transferred more or less into the centre region of the transfer system 1 and at least into the conveyor plane 26 of the lifting and conveying mechanism 25, which is substantially rectangular or square in shape as viewed from above. In particular, the conveyed item 3 can also be transferred in a straight line from the conveyor unit 4; 11 onto a conveyor unit 24—FIG. 1—or conversely fed along so that the conveyed item is continuously moved along past the transfer system 1.

In order to transfer conveyed items 3 between conveyor units 4; 11 and 5, 6 extending at an angle to one another, the following sequence can be performed at the transfer system 1: as soon as the bottom face 36 of the arriving conveyed item 3 sits at least partially within the conveyor plane 26 or at least partially on a level with the brake surfaces, in particular the brake bars 39, 40, the drive system 46 is set in motion. As a result the brake mechanism 35 is switched to the active position 86, in which the brake surfaces or brake bars 39, 40 thereof sit on the same level as the conveyor plane 21, but are preferably lifted slightly above the level of the conveyor plane 21. When the brake mechanism 35 is in this active position 86, the brake elements 37, 38 or the brake surfaces of the brake bars 39, 40 enter into a friction contact with the bottom face 36 of the conveyed item 3. A conveyed item 3 being fed along the conveyor unit 4; 11 is therefore at least decelerated via the brake mechanism 35, in particular by means of the friction or braking surfaces thereof, and optionally brought to a complete halt. The oncoming conveyed item 3 can be brought to a halt primarily if its bottom face 36 is completely lifted off the conveyor unit 4; 11 by the brake mechanism 35 and the brake elements 37, 38 are long enough or exert a sufficient braking action. Advantageously, the feed rate of the conveyor unit 4; 11 can therefore be kept continuous.

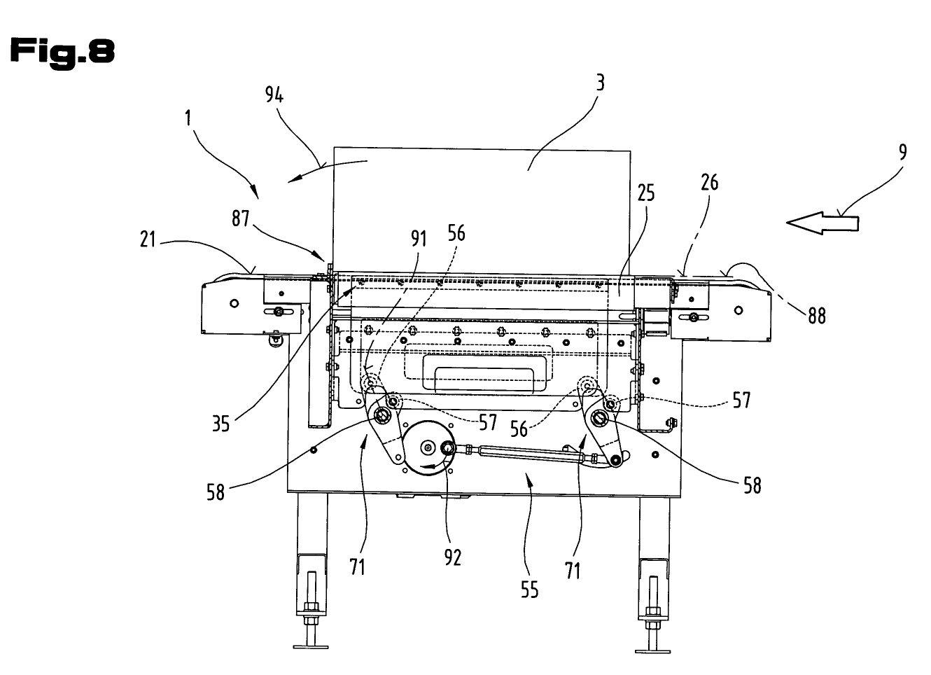

The kinetic energy of the conveyed items 3 is preferably not absorbed by the brake mechanism 35 alone, and instead a stop element 87 is preferably provided, by means of which the conveyed item 3, already slowed down via the brake mechanism 35, can be brought to a total standstill on the transfer system 1. This stop element 87 is preferably provided on the lifting and conveying mechanism 25, in particular on the bearing frame 29 thereof. The stop element 87, which might be a bar arrangement for example, projects at least slightly above the conveyor plane 26 of the lifting and conveying mechanism 25. The stop element 87 is disposed on the lifting and conveying mechanism 25 and its height can be adjusted by means of the raising and lowering function of the latter, and once it is projecting above the conveyor plane 21, the feed path for the conveyed item 3 is delimited by the region of the transfer system 1. A conveyed item 3 that was previously slowed down by the brake mechanism 35 is then brought to a complete halt via the stop element 87 in the end region of the deceleration run of the brake mechanism 35 as at least the bottom, front edge or peripheral region of the conveyed item 3 hits the stop element 87. Conveyed items 3 fed along in the direction of the brake action of the brake mechanism 35 sliding towards or transversely to the actual feed direction—arrow 34—of the lifting and conveying mechanism 25 are therefore totally halted, preferably at the latest on a level with the rigidly mounted stop element 87, as may be seen from FIG. 8.

At the latest after the conveyed item 3 has come to a halt on the stop element 87 jutting into the conveyor plane 21 or projecting above the conveyor plane 26, the transverse feed of the conveyed item 3 can be initiated. To this end, the conveyed item 3 is picked up by the lifting and conveying mechanism 25 or by the brake mechanism 35 and transferred to the lifting and conveying mechanism 25. This is done by raising the conveyor plane 26 of the lifting and conveying mechanism 25 above the level of the brake mechanism 35 or its brake surfaces and/or the brake mechanism 35 transfers the load of the conveyed item 3 to the lifting and conveying mechanism 25 as the brake surfaces of the brake mechanism 35 are lowered again. Preferably, the conveyed item 3 is passed via the brake mechanism 35, as it starts to lower, to the lifting and conveying mechanism 25 at the same time as it is being raised above the conveyor plane 21. Simply by activating the drive system 51, the conveyed item 3 can then be fed away transversely to the feed direction—indicated by arrow 9—and transferred to another conveyor track that will feed the conveyed item 3 onwards. Accordingly, the conveyor function of the lifting and conveying mechanism 25 may be operated discontinuously or continuously.

The essential factor is that because of the crank drive 55 or the connecting drive 72, only a single one-directional drive system 46 need be provided in order to switch the brake mechanism 35 and the lifting and conveying mechanism 25 between their initial or non-operating positions 84, 85 and the active position 86 for the brake mechanism 35 and an active position 88 for the lifting and conveying mechanism 25 and vice versa. When the lifting and conveying mechanism 25 is in the active position 88, its conveyor plane 26 is raised at least slightly above the substantially horizontal conveyor plane 21, thereby enabling the conveyed item 3 to be fed away transversely unhindered and without jamming. The other essential aspect is that when the lifting and conveying mechanism 25 is in the active position 88, the brake mechanism 35 is inactive because the brake surfaces or brake elements 37, 38 are at least slightly below the level of the active position 88 of the lifting and conveying mechanism 25.

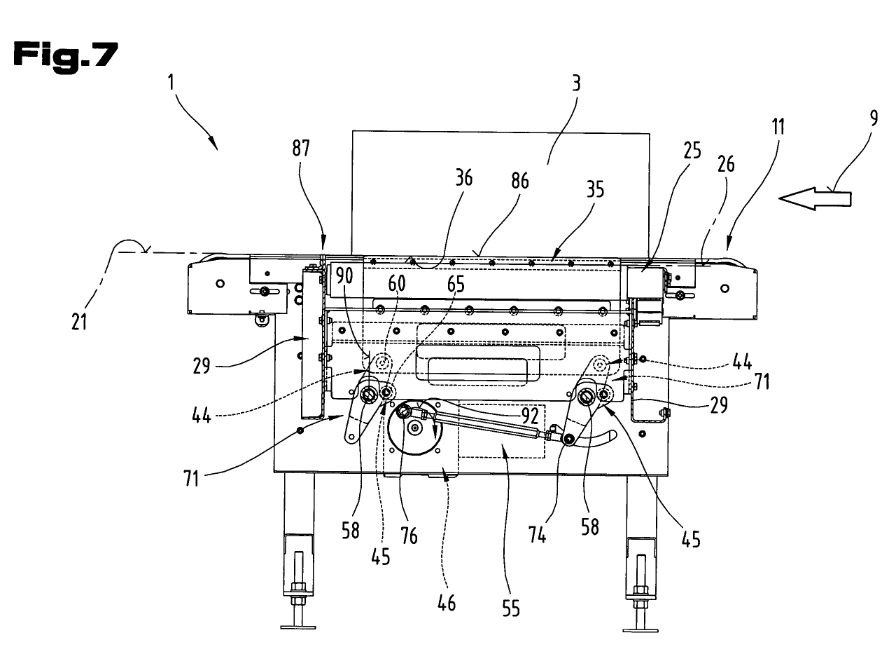

The three functions of the brake mechanism 35—namely inactive, active and transfer to the lifting and conveying mechanism 25—are preferably operated such that the positioning mechanism 44 and the positioning arm 56 for the brake mechanism 35 are displaced between a first bottom dead centre 89, a top dead centre 90 and another bottom dead centre 91, as diagrammatically illustrated in FIGS. 7 to 9. In particular, the articulated link 60 is at a bottom dead centre 89 position when the brake mechanism is in the initial or non-operating position 84—as illustrated in FIG. 6. When the brake mechanism 35 or its brake surfaces are in the maximum raised position, the articulated link 60 is at a top dead centre 90—FIG. 7—in which the friction or brake surfaces engage or are in contact with the conveyed item 3. In another sequence, the articulated link 60 passes through a second bottom dead centre 91 —FIG. 8—as the drive system continues operating, in particular continues rotating, in which the brake mechanism 35 is moved back slightly lower than the position at the top dead centre 90. In other words, the brake mechanism 35 effects a two-way vertical displacement via the positioning mechanism 44 and the positioning arm 56 between three different height positions, the highest position of the brake mechanism 35 being between the relatively lower first and third positions of the brake mechanism 35.

The advantage of this embodiment of the invention is that the brake mechanism 35 and the lifting and conveying mechanism 25 can be returned to their initial or non-operating positions 84, 85, with one full rotation of the crank wheel 75 only or a corresponding crank bar, as may be seen from FIG. 6. To complete a full work cycle of the transfer system 1, the crank wheel 75 of the drive system 46 is displaced in a one-way rotating motion about 360° as indicated by arrow 92. This represents a considerable simplification in terms of control technology, because in the most basic of situations only one sensor 92 is needed to detect conveyed items 3 as they approach the transfer system 1, which sensor 92 can also be used to detect any approaching conveyed items 3 that has got stuck in the region of the conveyor plane 26 of the lifting and conveying mechanism 25. This sensor 92 is connected to an electronic control system, not illustrated, to which it transmits the corresponding detection values so that the drive system 46 and/or the drive system 51 can be activated accordingly in which ever automated sequence is necessary.

Another sensor 93 or transmitter may optionally be provided, by means of which the drive system 46 is brought to a standstill once the crank wheel 75 or an appropriate crank drive has completed a full revolution.

Turning the crank wheel 75 by a full rotation effects a full work cycle of the brake mechanism 35 and the lifting and conveying mechanism 25.

By making the drive system 46 reversible, it would also be possible to rotate the crank drive 55 or the crank wheel 75 by only a fraction of 360°, for example by a half rotation in order for the brake mechanism 35 and the lifting and conveying mechanism 25 to perform a full work cycle. However, this is somewhat more complex in terms of control technology.

Also clearly illustrated in FIGS. 6 to 8 is the fact that the brake mechanism 35, in particular the brake bar 39, 40 thereof, effects a combined vertical motion perpendicular to the conveyor plane 21 and simultaneously a horizontal motion via the rotatably mounted positioning mechanism 44, in particular via the positioning arms 56. Specifically, this is due to the positioning arms 56, which are mounted so as to pivot or rotate about the pivot axis 58.

Likewise, the lifting and conveying mechanism 25 also effects a combined vertical motion perpendicular to the conveyor plane 21 and simultaneously a horizontal motion via the rotatably mounted positioning mechanism 45 or the positioning arms 57 thereof. This is also due to the positioning arms 57, which are mounted so as to pivot about the pivot axis 58.

Via the positioning mechanism 44, therefore, the brake mechanism 35, in particular the brake surface thereof, pivots out above the conveyor plane 21 and back down below the pivot plane 21. The lifting and conveying mechanism 25 is preferably also lifted in a pivoting motion above the conveyor plane 21 and is then lowered back down below the conveyor plane 21.

Another conceivable alternative would be to provide the drive system 46 as a piston and cylinder unit, thereby generating a linear adjusting motion for the positioning mechanisms 44, 45. Alternatively, the raising and lowering motion of the lifting and conveying mechanism 25 could be produced by a linear motion, operated by a piston and cylinder unit, for example.

This combined vertical and horizontal motion pivoting out from the conveyor plane 21 and generated by the positioning arms 56 is of particular practical use primarily in the case of the brake mechanism 35. Due to the fact that the brake mechanism 35, in particular at least one brake bar 39, 40 thereof, is moved both in the vertical direction perpendicular to this conveyor plane 21 and simultaneously also in the horizontal direction and parallel with the feed direction—arrow 9—of the first conveyor unit 4; 11 when moved into the active position 86, a conveyed item 3 running onto the brake mechanism 35, in particular one of the brake surfaces of the brake bars 39, 40, can be actively pushed against the stop element 87. Specifically as a result of the active horizontal displacement of the brake mechanism 35, a conveyed item 3 picked up by the brake elements 37, 38 or the brake bars 39, 40 can be actively and drivingly forced against the bar-shaped stop element 87, for example. Consequently a conveyed item 3 that has moved askew or twisted can be easily straightened as it is fed along and decelerated. It is primarily as a result of this active straightening of the conveyed item 3 brought about by the pivoting motion of the brake mechanism 35 that the regions of the edges of the conveyed item 3, which is square-shaped or cuboid, runs as far as possible parallel with and at a right angle to the conveyor mechanisms—arrow 9 and arrow 34—of the conveyor units 4; 11 and 5, 6. This active aligning motion applied by the drive system 46 helps to ensure that the conveyed item 3 is transferred or passed correctly and free of problems between conveyor units 4; 11 and 5, 6 extending at an angle to one another. For example, a conveyed item 3 that has not run completely onto the stop element 87 can be more correctly oriented and straightened on the stop element 87 by the active pushing movement. This pivoting or curved pushing movement is indicated by arrow 94 in FIG. 8. In addition to its braking function, the brake mechanism 35 also actively performs a function whereby it straightens the conveyed item 3 if the brake mechanism 35 co-operates with a stop element 87.

This action of pushing and catching the conveyed item 3 performed by the brake mechanism 35 as indicated by arrow 94 is due to the advantageously pivot-mounted positioning mechanism 44 and by the pivoting action of the positioning arms 56 for the brake mechanism 35 about the pivot axis 58. The linkage of the positioning arm 56 on the bearing shaft 62 is therefore fixed in such a way that when the bearing shaft 62 is rotated about the pivot axis 58, the brake mechanism 35, in particular at least one of the brake bars 39, 40 thereof, is displaced in the vertical direction perpendicular to the conveyor plane 21 and also in the horizontal direction towards the stop element as it is being switched into the active position 86 and when in the active position, as indicated by arrow 94.

As also clearly illustrated in FIGS. 6 to 8, the positioning arm 56 for the brake mechanism 35 is aligned more steeply by reference to the pivot plane 66 than the positioning arm 57 for the lifting and conveying mechanism 25. In other words, when the bearing shaft 62 is pivoted about the pivot axis 58, the positioning arm 56 for the brake mechanism 35 passes closer to a top dead centre 90 of this pivoting motion than the positioning arm 57 for the lifting and conveying mechanism 25. As a result, as the lifting and conveying mechanism 25 is being lifted out from its initial or non-operating position 85—FIG. 6—into its active position 88—FIG. 8—above the conveyor plane 21, the brake mechanism 35 effects a lifting and lowering motion when the positioning arm 57 passes through the top dead centre 90. This causes a virtual return of the brake mechanism 35 whilst the lifting and conveying mechanism 25 continues to move upwards to the highest level or the active position 88—FIG. 8—and therefore takes over the load of the conveyed item 3 in order to make the transverse feeding action possible.

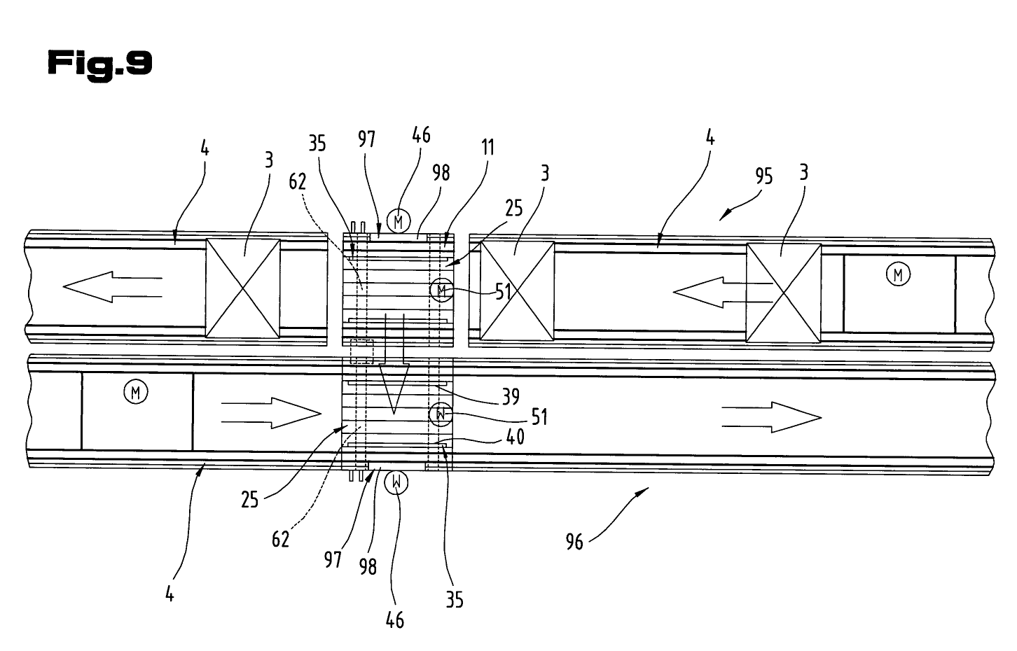

FIG. 9 depicts a plan view of one possible embodiment of a conveyor system 2, in which two transfer systems 1 proposed by the invention are used.

In this instance, two parallel conveyor tracks 95, 96 are provided. These conveyor tracks 95, 96 feed the conveyed items 3 in opposite directions, for example, as indicated by arrows.

By means of the transfer systems 1, it is therefore possible to pass and transfer conveyed items 3 from the feed flow of one conveyor track 95 to the other conveyor track 96.

This conveyor system 2 basically enables X-, Z- or U-shaped transport routes to be set up for the conveyed items 3 because of the advantageous functions provided by the transfer systems 1. Accordingly, by using the functions of the brake mechanism 35 and the lifting and conveying mechanism 25 of the two transfer systems 1, it is possible to set up conveyor tracks for the conveyed items 3 in a crossing and branching arrangement.

As also schematically illustrated, the lifting and conveying mechanism 25 may also be provided with a stop mechanism 97. This stop mechanism 97 delineates the route by which conveyed items 3 are fed onto the lifting and conveying mechanism 25. In particular, this system prevents the conveyed items 3 from running beyond the end of the feed run of the lifting and conveying mechanism 25. This stop mechanism 97 may be provided either as a rigid or as a damping stop element 98 for the conveyed items 3. The stop element 98 may be provided on the base frame of the transfer system 1 or on the bearing frame of the lifting and conveying mechanism 25.

If a specific conveyed item 3 on the conveyor system 2 has to be transferred via the transfer system 1 from the conveyor track 95 onto the conveyor track 96, the brake mechanism 35 and the lifting and conveying mechanism 25 of the transfer system 1 then come into play for this purpose.

The transfer system 1 is also constructed so that at least the drive system 46 for the brake mechanism 25 and for the lifting and conveying mechanism 35 can be mounted selectively on one of the two opposite sides of the transfer system 1 or the base frame thereof. This offers a high degree of flexibility in practical applications and means that the transfer system 1 can be set up in a plurality of different configurations. Moreover, it is possible for the conveyor tracks 95, 96 to be disposed relatively close to one another. If the distance between the two parallel conveyor tracks 95, 96 is longer than the linking element between the two transfer systems 1, a conveyor unit can be provided with a part-section that is either driven or free-running.

FIG. 9 also illustrates the difference between a continuously extending conveyor unit 4 or conveyor track 96 and conveyor units 4 which adjoin or dock onto the transfer system 1, in which case the transfer system 1 requires an additional separate conveyor unit 11.

As is also evident, when the brake mechanism 35 is inactive and the lifting and conveying mechanism 25 is inactive or lowered, the conveyed items 3 can be fed continuously and in a straight line on the conveyor tracks 95 and. 96.

Another advantage of the transfer system 1 proposed by the invention resides in the fact that it can be used to decelerate conveyed items 3 as they are being fed longitudinally or horizontally without having to make any significant modifications. Particularly when transferring conveyed items 3 from the transfer system 1 in conveyor track 95 to the transfer system 1 in conveyor track 96, the latter transfer system 1 can be used to transversely decelerate oncoming conveyed items 3 as indicated by the arrow. The two transfer systems 1 coupled with one another accordingly are of an identical mechanical structure in this particular instance and may be used to provide longitudinal deceleration for conveyed items 3 being fed along the conveyor tracks 95, 96 and to provide transverse deceleration for conveyed items 3 transferred between the conveyor tracks 95, 96.

Whilst the conveyed items 3 are being transferred from the conveyor track 95 to the conveyor track 96, the two transfer systems 1 are operating in the phase illustrated in FIG. 8, in which the lifting and conveying mechanism 25 is in the active position 88 and the brake mechanism 35 and the brake surfaces thereof lie underneath the conveyor plane 26 of the lifting and conveying mechanism 25.

Immediately an appropriate sensor system detects that a conveyed item 3 has arrived at least partially alongside or on the second transfer system I or is sufficiently close to this second transfer system 1, the drive system 46 on the second transfer system 1 receiving the conveyed item 3 is set in motion. Consequently, the brake mechanism 35 is gradually raised above the conveyor level of the lifting and conveying mechanism 25 as the lifting and conveying mechanism 25 is lowered and the brake mechanism 35 is simultaneously raised until the brake surfaces of the brake mechanism 35 are in a friction contact with the bottom face of the conveyed item 3. The almost transversely fed conveyed item 3 is therefore decelerated via the brake mechanism 35 or at least partially slowed down. Finally, the conveyed item 3 is passed by the brake mechanism 35, in particular the brake bars 39, 40 thereof, so that its load is transferred and it is passed as a result onto the conveyor unit 4, so that the conveyed item 3 can be fed onwards.

The brake mechanism 35 can therefore also be used when feeding conveyed items 3 transversely onto the transfer system 1 in order to slow down or decelerate the conveyed items 3 as they arrive and can be so in such a way that they hit the stop mechanism 97 with only a reduced amount of energy—if any at all. Consequently, there is no need to provide any expensive, i.e. damping mechanism 97 to provide a solid or complex damping action.

Optionally, it would also be possible to couple the bearing shafts 62 and the corresponding lift shafts of transfer systems 1 used in a parallel arrangement, as schematically indicated by broken lines. This being the case, only one drive system 46 will essentially be needed in order to operate the vertical displacement of the lifting and conveying mechanism 25 and the brake mechanism 35 of the two transfer systems 1.

Finally, for the sake of good order, it should be pointed out that in order to provide a clearer understanding of the structure of the transfer system 1, it and its constituent parts are illustrated to a certain extent out of proportion and/or on an enlarged scale and/on on a reduced scale.

The independent solutions proposed by the invention as a means of achieving the set objective may be found in the description.

Above all, the individual embodiments illustrated in the individual drawings of FIGS. 1 to 8 and 9 may be construed as independent solutions proposed by the invention in their own right. The set objectives and associated solutions may be found in the detailed description of the these drawings.

List of Reference Numbers 1 Transfer system 2 Conveyor system 3 Conveyed item 4 Conveyor unit 5 Conveyor unit 6 Conveyor unit 7 Conveyor element 8 Conveyor element 9 Arrow 10 Peripheral region 11 Conveyor unit 12 Conveyor element 13 Conveyor element 14 Conveyor belt 15 Conveyor belt 16 Return pulley 17 Return pulley 18 Distance 19 Rotation axis 20 Rotation axis 21 Conveyor plane 22 Standing plane 23 Sub- or support frame 24 Conveyor unit 25 Lifting and conveying mechanism 26 Conveyor plane 27 Conveyor element 28 Conveyor element 29 Bearing frame 30 Conveyor roller 31 Conveyor roller 32 Rotation axis 33 Rotation axis 34 Arrow 35 Brake mechanism 36 bottom face 37 Brake element 38 Brake element 39 Brake bar 40 Brake bar 41 Width 42 Length 43 Distance 44 Positioning mechanism 45 Positioning mechanism 46 Drive system 47 Geared motor 48 Electric motor 49 Brake hold mechanism 50 Gear system 51 Drive system 52 Geared motor 53 Electric motor 54 Belt drive 55 Crank drive 56 Positioning arm 57 Positioning arm 58 Pivot axis 59 End 60 Articulated link 61 Pivot bearing 62 Bearing shaft 63 Base frame 64 End 65 Articulated link 66 Pivot plane 67 Angle 68 Length 69 Length 70 Drive arm 71 Swing lever 72 Connecting drive 73 Coupling rod 74 Articulated link 75 Crank wheel 76 Articulated link 77 Distance 78 Motion-transmitting element 79 Motion-transmitting element 80 Bearing mechanism 81 Bearing mechanism 82 Bearing element 83 Support roller 84 Initial or non-operating position 85 Initial or non-operating position 86 Active position 87 Stop element 88 Active position 89 Bottom dead centre 90 Top dead centre 91 Bottom dead centre 92 Sensor 93 Sensor 94 Arrow 95 Conveyor track 96 Conveyor track 97 Stop mechanism 98 Stop element

What is claimed is:

1. Transfer system for items conveyed piece by piece between a first conveyor unit and at least one other conveyor unit extending transversely or at an angle thereto, whereby the conveyed items can be fed on a substantially horizontal conveyor plane, which conveyor plane is defined either by at least two conveyor elements of a first conveyor spanning the transfer system or by separate conveyor elements of a first conveyor unit disposed directly on the transfer system, characterised in that a brake mechanism is provided which can be raised above and lowered below the conveyor plane so that it can be selectively placed in and out of friction contact with the bottom face of the conveyed item as well as a lifting and conveying mechanism, the conveyor elements of which can be raised and lowered so that the conveyed item can be picked up from the first conveyor unit and transferred onto one of the other conveyor units without jamming, whereby a first positioning mechanism for the raisable and lowerable brake mechanism and a second positioning mechanism for the lifting and lowering action of the lifting and conveying mechanism are mechanically coupled in displacement and are linked to one another by a common first drive system only.

2. Transfer system as claimed in claim 1, characterised in that the first conveyor unit in the conveyor plane has mutually spaced circulating conveyor elements in the form of an endless loop, in particular conveyor chains or conveyor belts.

3. Transfer system as claimed in claim 1, characterised in that the conveyor elements of the lifting and conveying mechanism are provided in the form of a plurality of conveyor rollers, the axes of rotation of which extend parallel with the feed direction of the first conveyor unit.

4. Transfer system as claimed in claim 3, characterised in that the conveyor rollers are mounted on a common bearing frame of the lifting and conveying mechanism.

5. Transfer system as claimed in claim 4, characterised in that a drive system for the conveyor rollers is attached to the bearing frame.

6. Transfer system as claimed in claim 5, characterised in that the drive system is linked via a chain or belt drive so as to displace a plurality of conveyor rollers.

7. Transfer system as claimed in claim 1, characterised in that the first drive system has an electric motor which drives in one direction.

8. Transfer system as claimed in claim 1, characterised in that the first drive system is a self-inhibiting gear mechanism, a brake motor or a brake hold mechanism that can be otherwise activated as and when necessary for the positioning mechanisms of the brake mechanism and the lifting and conveying mechanism.

9. Transfer system as claimed in claim 1, characterised in that the first drive system is coupled via a crank drive or a push-crank arrangement or a connecting drive so as to displace the positioning mechanisms.

10. Transfer system as claimed in claim 9, characterised in that, from an initial or non-operating position below the conveyor plane, the brake mechanism and the lifting and conveying mechanism are returned to these initial or non-operating position after a complete rotation of a crank wheel or a crank arm of the crank drive or connecting drive.

11. Transfer system as claimed in claim 1, characterised in that the positioning mechanisms are provided in the form of at least one rotatably mounted swing lever.

12. Transfer system as claimed in claim 11, characterised in that the swing lever has two positioning arms spaced apart at an angle or offset from one another within a pivot plane.

13. Transfer system as claimed in claim 12, characterised in that the positioning arm is displaceably coupled with the brake mechanism or a brake element and the other positioning arm are displaceably linked to the lifting and conveying mechanism.

14. Transfer system as claimed in claim 11, characterised in that the swing lever has three arms, one being a drive arm and the other two being positioning arms.

15. Transfer system as claimed in claim 14, characterised in that the drive arm is articulatingly linked to the crank drive or connecting drive, in particular to the coupling rod thereof.

16. Transfer system as claimed in claim 14, characterised in that the drive arm and the two positioning arms are secured to a common bearing shaft.

17. Transfer system as claimed in claim 16, characterised in that the two positioning arms are disposed at a distance from one another in the longitudinal direction of a pivot axis of the bearing shaft.

18. Transfer system as claimed in claim 1, characterised in that two oppositely lying end regions of the brake mechanism, in particular a brake bar, respectively cooperate with a first positioning mechanism.

19. Transfer system as claimed in claim 1, characterised in that two oppositely lying end regions of the bearing frame for the lifting and conveying mechanism cooperate respectively with a second positioning mechanism.

20. Transfer system as claimed in claim 18, characterised in that the mutually spaced first positioning mechanisms are coupled in displacement via a dimensionally stable element or a brake element of the brake mechanism.

21. Transfer system as claimed in claim 19, characterised in that the mutually spaced second positioning mechanisms are coupled in displacement via the bearing frame.

22. Transfer system as claimed in claim 17, characterised in that the bearing shaft is rotatably mounted on a base frame or sub- or support frame of the transfer mechanism.

23. Transfer system as claimed in claim 22, characterised in that bearing mechanisms are respectively provided on each of the distal end regions of the bearing shaft, which are secured to the base frame or sub- or support frame.

24. Transfer system as claimed in claim 1, characterised in that the brake mechanism, in particular its brake bar, effects a combined vertical and horizontal motion via the rotatably mounted positioning mechanism.

25. Transfer system as claimed in claim 1, characterised in that the lifting and conveying mechanism effects a combined vertical and horizontal motion via the rotatably mounted positioning mechanism.

26. Transfer system as claimed in claim 24, characterised in that the brake mechanism, in particular at least one brake bar thereof, it is displaced by the positioning mechanism into its active position above the conveyor plane, being moved in the vertical direction perpendicular to the conveyor plane as well as in the horizontal direction in the direction of the feed direction—arrow—of the first conveyor unit.

27. Transfer system as claimed in claim 1, characterised in that a stop element is provided for the conveyed goods, aligned parallel with the feed direction—arrow—of the lifting and conveying mechanism.

28. Transfer system as claimed in claim 27, characterised in that the stop element is secured to the bearing frame of the lifting and conveying mechanism and projects above the conveyor plane thereof.

29. Transfer system as claimed in claim 28, characterised in that when the brake mechanism, in particular at least a brake bar thereof, is moved into its active position via the positioning mechanism, it is moved in the vertical direction perpendicular to the conveyor plane as well as in the horizontal direction in the direction towards the stop element.

30. Transfer system as claimed in claim 27, characterised in that, by reference to the feed direction—arrow—of the first conveyor unit, the stop element is disposed in an end region of the brake mechanism.

31. Transfer system as claimed in claim 1, characterised in that an end of a positioning arm of the positioning mechanism for the brake mechanism spaced at a radial distance apart from the pivot axis or bearing shaft can be displaced starting from a first bottom dead centre, through a top dead centre to another bottom dead centre and vice versa.

32. Transfer system as claimed in claim 31, characterised in that the end of the positioning arm travels across a displacement path starting from a first bottom dead centre, through a top dead centre to another bottom dead centre after a half rotation of the crank drive, in particular the crank wheel thereof, and lies at the first bottom dead centre again after a full rotation of the crank drive.

33. Transfer system as claimed in claim 31, characterised in that the end of the positioning arm is coupled via an articulated link so as to displace the brake mechanism, in particular the brake element or brake bar thereof.

34. Transfer system as claimed in claim 12, characterised in that a length of the positioning arm for the brake mechanism is longer than a length of the positioning arm for the lifting and conveying mechanism.

35. Transfer system as claimed in claim 12, characterised in that, by reference to its pivot plane, the positioning arm for the brake mechanism is more steeply aligned, in particular lies closer to a top dead centre of its pivoting motion when pivoted about the pivot axis, than the positioning arm for the lifting and lowering function of the lifting and conveying mechanism.

36. Transfer system as claimed in claim 1, characterised in that a stop element for the conveyed item is provided in an end region of brake surfaces or brake bars of the brake mechanism by reference to the feed direction—arrow—of the first conveyor unit.
